(19) United States
(12) Patent Application Publication
(10) Pub. No.: US 2026/0093460 A1
(43) Pub. Date: Apr. 2, 2026

(54) Embedded software build tool delivery

(71) Applicant: Mohammad Rakib Hassan Mullick, Dhaka (BD)

(72) Inventor: Mohammad Rakib Hassan Mullick, Dhaka (BD)

(73) Assignee: Mohammad Rakib Hassan Mullick, Dhaka (BD)

(21) Appl. No.: 18/900,946

(22) Filed: Sep. 30, 2024

(51) Int. Cl. G06F 8/30

(52) U.S. Cl. CPC G06F 8/30

(57) ABSTRACT

A system for delivering hardware vendor specific embedded software build tool for task-specific, resource-optimized devices such as systems-on-chip (SoC) and systems-on-module (SoM). The system includes plurality of executor nodes configured with a specific build tool with a build executor script waiting to be triggered by the users via a RESTful API, to get an intended software image for a particular SoC/SoM. Middleware and node managers help select and distribute requests across multiple executor nodes. The system generates firmware or operating system images optimized for resource-constrained devices, such as those used in industrial, medical, or IoT applications, and outputs the image for deployment. By utilizing this system hardware vendors can improve the existing process of embedded software build tool delivery and help developers work faster and ensures optimal performance on specialized, non-generic hardware architectures.

### BACKGROUND OF THE INVENTION

The Internet of Things (IoT) has transformed the landscape of hardware-based products across various sectors, including consumer electronics, automotive, and industrial automation. This shift has driven an increasing demand for sophisticated non-generic (specialized) hardware platforms shipped as System-on-Chip (SoC) or System-on-Module (SoM) solutions capable of meeting the unique requirements of these diverse industries.

In the past, embedded devices typically performed simple tasks such as basic calculations, motor control, or temperature display. However, modern devices have evolved to become significantly more complex. Now-a-days even a small household appliance may possess the capability to communicate with cloud servers, continuously read and transmit data, and enable a wide array of application scenarios. Such advanced functionality necessitates the use of complex and specialized SoC/SoM systems rather than simple microcontrollers.

Central to the functionality of these hardware systems is the software that drives them. In microcontroller-based systems, this software is commonly referred to as firmware, typically programmed directly onto a chip, sometimes with reprogramming capabilities. For microprocessor-based systems, the software is generally termed an operating system (OS). For simplicity, OS and OS-less systems both will be referred to as “firmware” or “firmware image” or “software image” and will be used interchangeably in the context of this writing. Microprocessor software images, containing various tools and utilities, tend to be larger and often require loading from external storage devices with bootloader assistance during initialization.

The increasing complexity of SoCs/SoMs, which integrate multiple processing cores, memory interfaces, peripherals, and other functionalities onto a single chip, has created new challenges in firmware development. Effectively utilizing the capabilities of these devices requires specialized skills and tools. Recognizing this, SoC/SoM vendors have developed various methods for delivering resources to firmware developers, including Software Development Kits (SDKs), Integrated Development Environments (IDEs), documentation, debugging tools, and Firmware Development Kits (FDKs).

Firmware developers often prefer Free and Open Source licensed tools, which allow for studying, modification, sharing, and unrestricted use. This preference has led to the widespread adoption of GNU/Linux-based OS distributions for SoC/SoM hardware. Two well-known GNU/Linux-based OS distribution generation tools, Yocto and Buildroot, are commonly supported by hardware vendors. Toaster is an web based GUI on top of Yocto, which still require the developers to setup, maintain an web infrastructure and it doesn't free from the fact that developers need to write their own recipes and other configurations details by hand. A commercial tools like TimeStorm, provide desktop IDE for embedded Linux based application development whereas another tool called Factory that allows embedded Linux customization via desktop or cloud, however these tools only specific to Linux based OS, need to develop and maintain their own board support package (BSP), and doesn't minimize the gap in developer-to-developer communication due to lack of straight-forward way of using and the end users need more flexibility in terms of firmware or OS image preparation for a particular SoC/SoM.

These OS distribution generation tools build the target OS image from scratch, compiling each component of the target OS. This process requires detailed configuration information, including any necessary modifications or patches, installation details, and other specific requirements for each software component. In Yocto, for example, this information is organized in files called “recipes”, which must be written in a specific format interpretable by the Yocto build engine.

While powerful, these tools present significant challenges. They require extensive knowledge of the build system, including how to write and manage recipes. The modular approach of systems like Yocto, while flexible, introduces bootstrapping issues and demands substantial knowledge of Yocto. Buildroot, while easier to work with, is less modular and can create maintenance challenges when supporting multiple SoCs. They both need to maintained by the developers which often lead them to setup, maintain their own build infrastructure.

For OS-less (often called “baremetal”) firmware images for microcontrollers, developers typically rely on vendor-provided SDKs. These SDKs usually include necessary toolchains, drivers, libraries, and documentation for effective hardware utilization.

The complexity of these development tools and processes creates significant hurdles for product development teams. Launching a product often involves an agile, iterative process, with teams experimenting through prototypes. However, if the costs associated with prototype development become too high due to the complexity of firmware development, it can adversely affect the entire development cycle.

Furthermore, once a product reaches the market, its software must be maintained throughout its lifetime. Product development teams lacking the necessary specialized skills may need to outsource or hire additional expertise, potentially impacting the product's success and increasing development costs.

While hardware vendors typically ship SoCs/SoMs with pre-installed firmware to demonstrate functional hardware, end-users mostly need to develop and install custom firmware to meet specific application requirements, ensure optimal performance, or address particular use cases. This customization is crucial as different products have vastly different requirements. For instance, a handheld device might require an advanced graphical user interface with sophisticated graphics capabilities, while an IoT gateway designed for continuous operation in harsh environments might have no need for such features.

### SUMMARY OF THE INVENTION

In an embodiment, a system is provided for embedded system build tool delivery for hardware vendors that allow automatic creation of custom software image for specialized or resource-optimized computing devices, such as in System-on-Chip (SoC) and System-on-Module (SoM). The system leverages a Representational State Transfer (REST) Application Programming Interface (API) (also called RESTful API) and a command processing engine to provide an interaction interface to the developers of SoC/SoM, allowing them to create their intended software image for a particular SoC/SoM. The plurality of executor nodes each is loaded with necessary build tools capable of generating software images for a particular SoC/SoM. In between the user facing RESTful API and the executor nodes, there exist a middleware and node manager component help processing requests coming from the users and redirect them to the appropriate executor node. The system makes it easy for developers to work with SoCs/SoMs, as they need to know how to use the RESTful API or how to trigger a software image build for the target SoC/SoM, compared to the existing practices where they need to learn about build tools and setup, maintain the build infrastructure to get the same results.

Utilizing the system, a hardware vendor or a third-party does not need to ship build tools including SDK, toolchains, libraries, Yocto/Buildroot modifications, documentation etc. directly to the developers, instead they can refer the RESTful API endpoints and how to use them. Developers only need to know about the RESTful APIs, which they can use by variety of means including from a command line utility, continuous integration (CI) pipeline or can develop a graphical user interface (GUI) etc. This approach is straightforward and user-friendly method of interaction, contrary to the current approach of reading hardware vendor provided manual, learning a particular build tool, setting up and maintaining build infrastructure etc. to carry out typical development task.

This approach offers several key advantages. First, it simplifies the process for developers by automating the generation of software images through RESTful API. Second, it improves the way hardware vendors are delivering firmware or OS image generation build tools, or SDK or toolchains. Third, it allows customized firmware or OS image generation for the target SoCs/SoMs, ensuring that they are fine-tuned to meet the specific constraints and task demands of these systems. Fourth, the system abstracts the complexities of the build platforms by providing an uniform RESTful API allowing developers to focus on their work without needing deep technical knowledge of the underlying processes. Fifth, it is scalable and flexible, as it can utilize multiple node managers and executor nodes to handle a wide variety of configurations. Additionally, because the system is an Internet based application, developers can generate and manage images remotely. Finally, this system produces deployable software images for non-generic, resource-optimized processors, ensuring that the end products are ready for deployment in specialized, task-specific environments.

### BRIEF DESCRIPTION OF DRAWINGS

FIG. 1 is a diagram showing components of a system to automatically create custom toolchain or firmware or operating system (OS) or over-the-air (OTA) update images specifically for resource-optimized computing devices, such as System-on-Chip (SoC) and System-on-Module (SoM) devices, according to an embodiment.

FIGS. 2-5 show different portions of a flowchart describing a typical build executor script of the system of FIG. 1.

### DETAILED DESCRIPTION OF THE INVENTION

The current landscape of firmware development for SoC and SoM devices presents significant challenges in terms of complexity, resource requirements, and the need for specialized knowledge. These challenges can impede product development, increase costs, and potentially impact the success of products in the market.

In an embodiment, a streamlined, accessible, and efficient approach to deliver embedded software build tools by hardware vendors for firmware development and customization, using a user facing interface driven by REST (Representational State Transfer) API (Application Programming Interface). The system may be used to automate the process of toolchain or firmware or operating system image generation for a target hardware platform based on user request, abstracting the complex build processes through a unified RESTful interface and a group of build executor nodes.

A RESTful API is a way for two systems, like a client (such as a web or mobile app) and a server, to communicate over a network. One key principle is that the communication between the client and server is stateless, meaning the server doesn't remember anything from previous requests. Every time the client sends a new request, it includes all the information the server needs to process it, and each request is treated as if it's the first one.

REST APIs typically use HTTP or HTTPS, the same protocols that browsers use to access websites. With REST APIs, the client asks the server for specific resources, like a list of users or details about a product by using URLs, and the server responds with the requested data. Different types of requests are made depending on what the client wants to do. For example, it can ask for data (GET), send new data (POST), update existing data (PUT), or delete something (DELETE).

By using RESTful APIs, this system abstracts the technical complexities of setting up and managing build infrastructure, allowing users to create hardware specific firmware or operating system (OS) images by specifying high-level configurations (like architecture and OS name). This approach helps the hardware vendors, including producers of SoCs, SoMs or third-party developers, to get rid off complex delivery method comprising, software develop kit (SDKs), SoC/SoM specific library, toolchain, customized Buildroot for a specific SoC/SoM, Yocto meta layers for GNU/Linux OS generation, documentations etc. that they are currently using as part of hardware entablement for a particular SoCs/SoMs. On the other-hand, the customers of such hardware modules, in broader sense the developers, does not need to go through the difficult and time-consuming process of learning about the deliverables comprising build tool, SDK, library, toolchain or documentation for the purpose of firmware or operating system (OS) image generation to effectively use the target hardware platform. They can simply familiarize themselves with the REST API to use the underlying build infrastructure. For example, a third-party hardware vendor currently prepares a Yocto meta-layer which contains necessary hardware board bring-up changes for a particular SoC/SoM and they hand out the meta-layer with a documentation instructing how to use Yocto and integrate the meta-layer. The receiving party without any prior knowledge of Yocto finds it difficult to work with and integrate the use of the tool on to their day to day development activity. If the third-party hardware vendor in this case were simply providing a RESTful API with preconfigured build infrastructure then the adoption of such complex delivery becomes much easier. This system allows hardware vendors to deliver software build tools for the creation of customized, resource-optimized toolchain, over-the-air (OTA) update or firmware or OS images tailored for the specialized hardware platform or SoCs/SoMs, addressing the unique challenges posed by the existing delivery scheme.

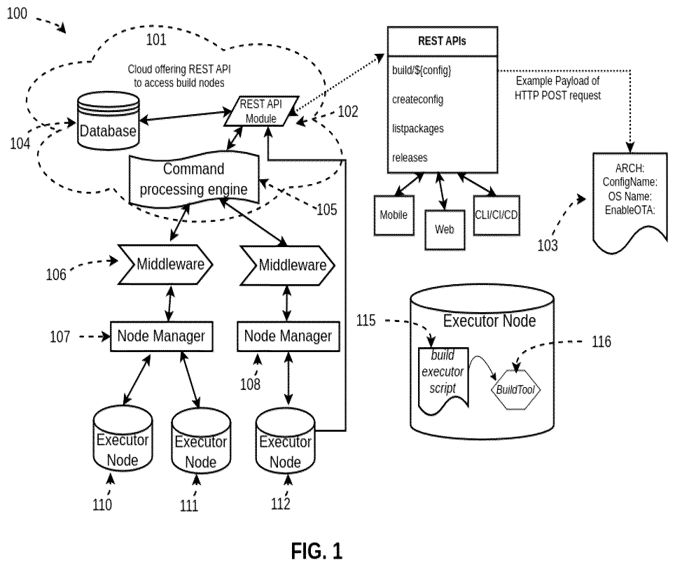

FIG. 1 illustrates a system diagram of an exemplary embodiment of a system 100 for delivering hardware vendor provided embedded software build tools that can generate development toolchain or firmware or OS images or OTA update images for a target SoCs/SoMs, such as those typically used in specialized devices and equipment and IoT devices.

The system comprises multiple components, each serving a specific function in the process of delivering hardware vendor provided embedded software build tool by allowing users request handling through the user facing interface (101) including REST API (102), command processing engine (105) and probably utilizing a database (104). The user facing interface (101) can be configured to directly receive input via command processing engine (105) bypassing the REST API module. In either case, the lower level functionality of the system will remain uniform. This REST API module (102) exposes several endpoints, some exemplary interface could be like, build/$ (config), createconfig, listpackages, and releases etc.

The REST API module (102) is designed to accept HTTP requests containing key parameters for initiating the build process. An exemplary payload (HTTP POST) (103) of such a request is shown, which comprising ARCH (target architecture), ConfigName (configuration name), OS Name, and Enable OTA (over-the-air updates flag) and may include further information. This streamlined API structure allows for easy integration with various client applications like, command line utility—curl and automation systems like, Jenkins, gitlab etc. while encapsulating the complexity of the underlying build process.

Adjacent to the REST API module (102), the user facing interface (101) may contain a database (104) for storing build configurations and other relevant data to facilitate the whole process, and a command processing engine (105) for interpreting and executing user requests. The command processing engine (105) can receives user input in various format including JSON, raw data format etc. and can be triggered by the REST API module (102) when it needs to access the underlying build infrastructure. The API module (102) passes build information by converting the request to the accepted format by the command processing engine (105). The command processing engine (105) pass it to the middleware (106) component which is responsible for maintaining a list of active node managers (107, 108).

The middleware (106) identifies various components like, target architecture, requested image type or requested build tool etc. from the user request and finds the responsible node manager (107, 108) from plurality of node managers. The middleware (106) acts as an intermediary between the user facing interface (101) and node managers (107, 108). The system may have plurality of middleware (106) components and in such case the command processing engine (105) determines which middleware to pick by analyzing the user provided request.

The plurality of node managers (107, 108) each capable of controlling its own list of executor nodes (110, 111, 112) and has the capability of selecting and triggering specific build executor script (115). These node managers maintains its own list of build executor nodes like, node manager (107) has two executor nodes (110, 111) and the node manager (108) has a single executor node (112). Each node manager knows the type of executor nodes they are controlling and what type of build tools each of the executor nodes are provisioned with. For the illustration purpose, multiple middleware, node managers and executor nodes are shown (110, 111, 112) but there could be any number of executor nodes between 1, 2, 3, 4, . . . , N.

A build executor script (115) is an executable program can be written in any programming language and is installed in the executor nodes (110, 111, 112). A BuildTool (116) is a generic term used in this context of writing and can comprise any build tool that is capable of generating a usable or installable firmware or OS image or development toolchain used for compatible application or firmware or OS image for the target architecture. Each executor nodes (110, 111, 112) loaded with such BuildTool (116) or a build executor script (115) that triggers software image generation process for a particular resource-constrained hardware or SoCs/SoMs etc. For example, a executor node can be provisioned with a build executor script (115) and Yocto (BuildTool in this case) build framework, in such case the build executor script (115) is written in a way that it knows how to control, configure, generate recipes, triggering build etc. for Yocto build framework to provide a software image for a particular specialized hardware platform (SoC/SoM). Another example, the build executor script (115) can control, configure and trigger build for Zephyr based firmware for resource-constrained computing devices that meant to run with OS-less firmware. Zephyr is a open source licensed Real-Time operating system (RT OS) that supports well known SoCs/SoMs, that can be found in resource-constrained devices including low-powered devices. By developing a build executor script (115) for a particular build tool and preparing a computing device that can execute the build executor script (115), a vendor or third-party can prepare a executor node (110/111/112) and provide a user facing interface (101) capable of receiving user request, can effectively replace the need for direct delivery of software build tools like, software development kit (SDK), toolchains, Yocto layers or documentation etc. with or without the help of middleware (106) or node managers (107, 108).

The entire system may be designed to automate the process based on user input to request OS or firmware image generation, abstracting complex build processes and maintenance of build infrastructure through a unified RESTful interface. This architecture allows for the creation of customized, resource-optimized firmware or operating system images tailored for specific embedded systems or IoT devices, addressing the unique challenges posed by headless or interface-constrained computing platforms. All the components 101, 106, 108/107, 110/111/112 may run on a single computer system or each could be running on multiple computing systems communicating over a network.

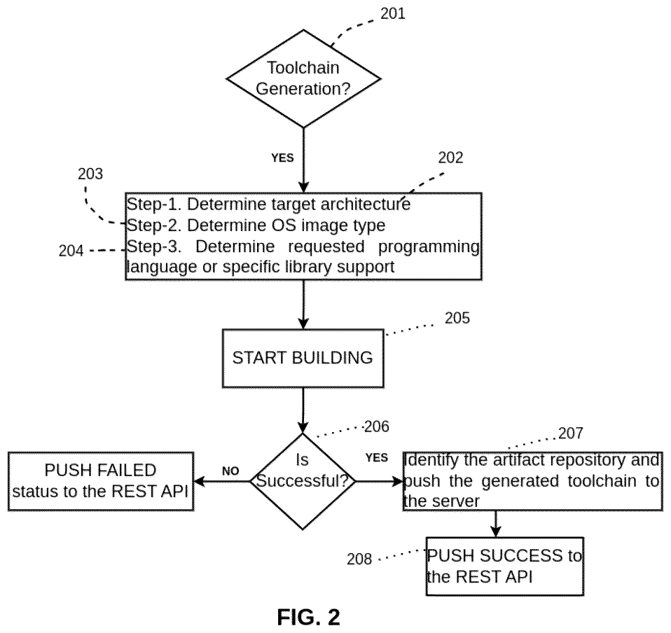

FIG. 2-FIG. 5 illustrates an exemplary flowchart outlining the decision-making process of a typical build executor script (115), in this flowchart a few specifics has been used like, Yocto for toolchain and OS image generation and Zephyr framework for OS-less firmware generation for demonstration purpose and can be adopted with any other build tools or IDEs for generation of toolchain or firmware or operating system images.

FIG. 2 illustrates an exemplary flowchart of a build executor script (115) that is responsible for generating a requested toolchain for a particular hardware platform (SoC/SoM). The process begins with an initial decision point “Toolchain Generation?” (201). This decision determines if the user has requested for a toolchain. If the decision at this step (201) is “Yes”, indicating that toolchain generation is requested, the system followup with toolchain generation process.

In step (202), the system identifies the specific hardware architecture of the target SoC/SoM is based on, such as ARM, RISC-V, x86 etc. The system then identifies the type of firmware or OS image the toolchain is to be generated for (203), which could include custom GNU/Linux OS or a baremetal environment, or other specialized OS types suited for resource-optimized computing devices. The system then determines if any specific programming language or library support is requested (204). This step involves identifying any specific programming languages or libraries that need to be supported by the toolchain which happens in case of GNU/Linux based operating systems, ensuring that the resulting toolchain will be compatible with the intended application development environment.

After determining the necessary elements for toolchain generation the system triggers the build process (205). After the build process, the system reaches a decision point “Is successful?” (206), which checks to ensures that if the toolchain was generated without errors. If the toolchain generation is successful, the process moves to identifying the artifact repository and push the generated toolchain (207). This step involves storing the newly created toolchain in a designated storage repository for future use or reference. Finally, the system pushes a success status to the REST API (208), updating the overall build status and notifying the user or calling system of the successful toolchain generation.

This toolchain generation process may be used to create optimized, compatible development environments for a specific target device, particularly those with unique architectures or specialized operating system requirements. By introducing this process, the system significantly reduces the complexity, improves flexibility for developers to build their own toolchain, less learning curve and less potential for errors if prepared by themselves. Developers can enjoy ultimate flexibility without relying on third-parties or other providers by utilizing the provided RESTful API.

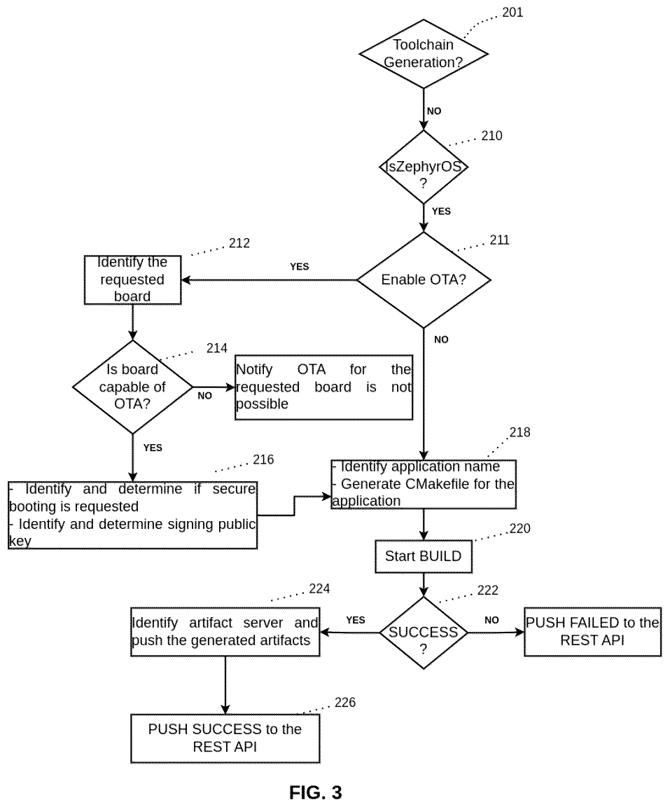

FIG. 3 illustrates a branch of the flowchart related to generation of firmware images based on Zephyr with possibility to generate OTA capable firmware. The process begins when no toolchain generation is requested (201) and by determining if ZephyrOS (a term used to refer Zephyr based firmware) based firmware generation is requested (210). Zephyr is widely used in IoT and embedded devices due to its support for low-power hardware and its extensive support for libraries including peripheral devices, communication stack etc.

If ZephyrOS is selected, the system next determines whether OTA updates should be enabled (211). OTA updates are critical in many IoT environments, as they allow the operating system and applications to be updated remotely without physical access to the device. In case of OTA enabled request, the system identifies the specific hardware board being used for the build (212) and determines if the identified board (SoC/SoM) has support for OTA update (214). If the support for OTA update is not available for the requested SoC/SoM, then it notifies the user and returns. This step ensures that the generated firmware image is tailored for the capabilities of the target hardware platform. To enable an OTA capable firmware image using ZephyrOS, a bootloader is required and in this case mcuboot is used. This step also makes sure the requested hardware board has the capability of providing OTA by determining necessary redundant flash image partition's availability, which is a prerequisite for mcuboot to work.

If the board is capable of OTA updates, the flow proceeds to configure security related configurations for the requested firmware image (216). The system identifies whether secure boot is requested, which is a feature that ensures the device will only boot software that has been verified as authentic. If secure boot is enabled, the system further identifies and determines a public key either directly via parameter or otherwise extracted by the system. The build system uses the public key to sign the firmware. A signed firmware is requested for secure booting purpose where bootloader is configured to check the authenticity of the firmware before booting or applying any OTA updates.

After security configurations are completed, the system identifies the application to be included in the firmware build (218). The application determines the characteristics of the target device and specifically written by the developers to meet a particular requirement of the product. Most of the product logic are part of the application. At this stage (218), a target application name is determined and the system generates a CMakefile for the target application. CMakefile is a specialized file used by a program called cmake, a widely adopted build system for managing the compilation of complex and multi-platform software projects. It simplifies the process by defining how the various components of the application are compiled and linked. The use of a CMakefile allows developers to abstract away low-level details such as toolchain specifics or platform differences, ensuring the build is portable across various platforms. Due to cmake's diverse advantages, Zephyr project use cmake for application build and it is invoked during the build process to generate the target firmware. In this context, the system generates CMakefile and enables the system to compile the application correctly for the specific hardware and OS configuration, without requiring extensive manual intervention.

Once the CMakefile has been generated, the system initiates the build process (220), where all necessary components, including the application, OS, and security features, are compiled into a final firmware image for the requested SoC/SoM. One of the key feature that Zephyr build system offers is it has the necessary toolchain for building the target firmware. Basically the hardware vendor does the necessary integration work as part of supporting their hardware for Zephyr. If the build is successful (222), the system identifies the appropriate artifact server (224) and pushes the generated firmware image and other build artifacts, such as OTA packages, to the server for storage and later use. Finally, the system pushes a success status to the REST API (226), which informs the user or external systems that the build has completed successfully.

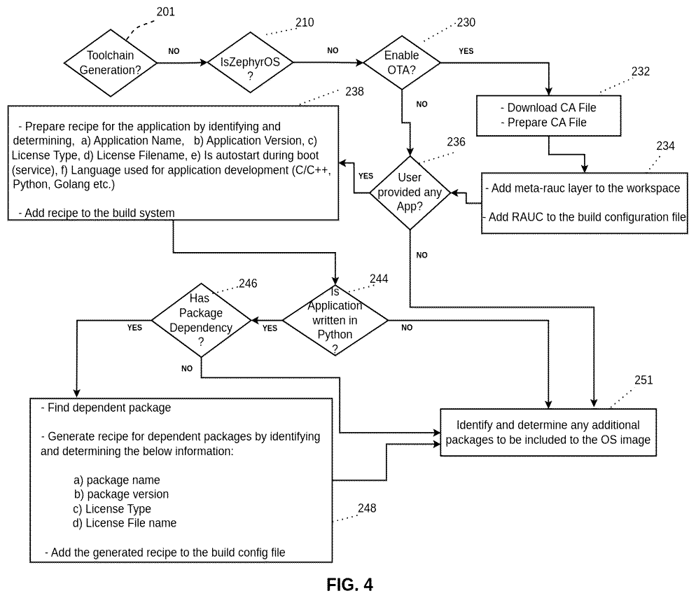

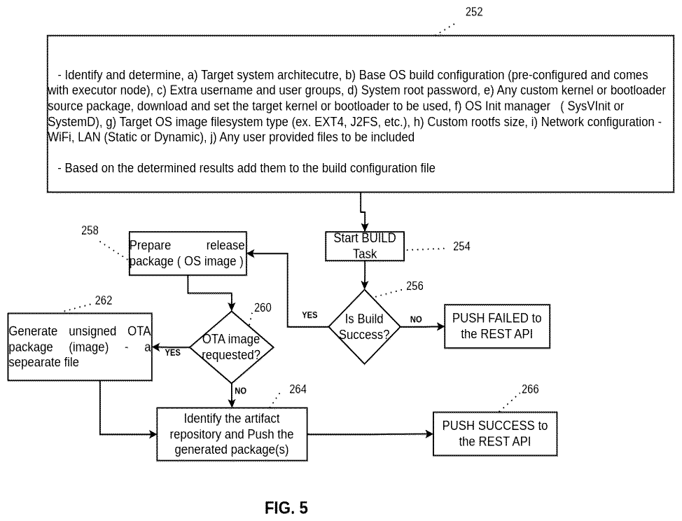

FIGS. 4 and 5 illustrate a process where a custom GNU/Linux based operating system (OS) image is built using Yocto build system. The process begins if no toolchain (201) and no ZephyrOS (210) is requested. This step start by determining whether OTA update has been requested for the target OS image (211). If the user chooses to enable OTA updates, the system proceeds to the preparation stage by downloading the key file (or provided directly as a parameter) and process the Certificate Authority (CA) file renaming to its appropriate name expected by the target OS build system (232).

In this instance, CA file is used by RAUC (Robust Auto-Update Controller)—a tool developed to update GNU/Linux based OS and bootloader. RAUC is a command line utility, it can work with various bootloader like, Uboot, Coreboot and relies on multiple partition scheme for applying OTA updates.

RAUC uses the CA file to determine the authenticity of the OTA image before applying and CA files are user generated therefore taken as input. With help of CA file RAUC ensures that the OTA image was not prepared by any unwanted party. A trusted party must have to sign the package with a private key corresponding to the CA file and then the authenticity of OTA package can be determined by RAUC. In conjunction with preparing the CA file, the build executor script also adds the meta-rauc layer to the workspace (234). meta-rauc is a Yocto compatible layer, released and maintained by the RAUC developers, meta-rauc contains necessary recipe for building and installing the RAUC package on to the target OS.

Following this, the system checks whether the user has provided any custom developed application (a user developed application) to be included in the target OS image (236). If an application is provided, the system prepares a recipe for the application (238), by identifying and determining essential information such as the application's name, version, development language (C/C++, Python3, Java, Golang etc.), license type, and whether it should autostart as a service during boot. This step also require the application to be pre-compiled and packaged in a particular order. Ensuring all the required parameters system generates a recipe for the target application. This recipe is required to generate the custom OS image that contains the requested user application. Once the recipe is prepared, it is added to the build system which will be invoked when the build starts.

The system then determines if the application from previous step (238) is developed using Python programming language or not (244). If yes, then it checks for if the application has any package dependency (246) which is very common for Python based application. Typically a Python application dependencies are outlined in a text file called requirements.txt containing the dependent application name and optionally version. If dependencies are detected, the system identifies the dependent packages (248), the system expects the dependent packages are organized in a particular file which should be inside the application folder prepared by the user, so the system can read the file after downloading the package the system generates a recipe for each dependent packages, gathering information such as the package name, version, license type, and license file (248). This ensures that all necessary dependencies are included in the final build, preventing runtime issues and missing packages during execution. Steps in this procedure (248) ends up by adding all the generated recipe to the build system.

The system then identifies any additional packages to be included in the target OS image (251). A build system such as Yocto contains recipe for various applications, system tools, utilities and they come as a default with the build system—at this stage system identifies and determine if any such tools or applications has been requested by the user and determine if it is possible to integrate. This step allows for further customization, offering users to add extra functionality or libraries tailored to the specific needs.

As a part of continuing configuration generation, system tries to determine further configuration options (252). This includes details about the requested build architecture (e.g., ARM, x86), the base OS build configuration file, and any custom usernames, groups or root passwords provided by the user. The configuration file also specifies whether a custom kernel is to be used, in which case the kernel source is downloaded and set as the target kernel. Similarly, user can request to overwrite the default Uboot based bootloader. Additional details, such as the OS initialization manager is determined at this stage, typically a GNU/Linux based OS offers two different type of OS initialization manager known as init system—they are Sys VInit and Systemd. To allow further customization this stage also determines if user requested any specific type of filesystem for root partition (e.g., ext4, j2fs), depending on the target hardware platform and storage devices (e.g., NAND, cMMC or SDcard etc.) the choice for suitable root partition's filesystem can vary. It's up to the user to find the best possible root partition's filesystem for them depending on the choice of the SoC/SoM or vendor recommended one. Normally the system comes with a default root partition size, however the system can determine if the a custom root partition size has been requested. In such case system determines if it is possible to accept the requested root partition size otherwise fall back to the default size. The system also looks for user provided network configuration and determines if, WiFi is enabled and if yes, reads the network configuration information and adds it to the corresponding build system's configuration file, in case of Yocto, it's the recipe file for wpa-supplicant where these information are added. Similarly LAN configuration are determined and a corresponding network configuration file is created and put as part of the build system as if, it gets included during the build and become part of the OS image. Finally, the system identifies whether the user has provided any additional files to be included in the target OS image, such as configuration files, scripts or any specific drivers, optionally with a target location under the root partition.

Once all these parameters are set, the system triggers the build task (254). The build system compiles the OS image, integrating all the selected applications, custom configurations data, and security features. This system uses Yocto as BuildTool (116) in this context. Yocto has the capability to reuse previously used build cache information which is very useful for developers producing OS build image regularly.

Following the build process, the system checks whether the build was successful (256). If the build is successful, the system proceeds to prepare the release package, which consists of the final OS image (258). At this point, if the user has requested an OTA image (260), then an unsigned OTA package is generated (262). Before using the generated OTA package it must be signed with the private key, that was part of the key generation process during the CA file generation. This particular OTA package is RAUC compatible OTA package and only can be used to update an OS that is properly configured to work with RAUC, such as the target OS must have rauc installed and have the same CA file that was generated along with the private key.

After the OTA package is generated, the build executor script (115) identifies the artifact repository (264), where the firmware image and OTA package (if generated) will be stored for future retrieval and deployment. The system then pushes the generated packages to the repository and updates the REST API module (102) with a success status (266), signaling that the build and packaging process has completed successfully.

The foregoing method descriptions and figures are provided as illustrative examples only. The order of operations in the aspects described herein may be performed in any order. Words such as “thereafter”, “then”, “next”, etc., are used to guide the reader through the description of the methods and systems described herein, and do not limit the order of the operations. Further, any reference to claim elements in the singular, for example using the articles “an,” or “the” is not to be construed as limiting the element to the singular. Also, relative terms such as “top,” “bottom.” “upper,” “lower,” “above,” “below,” and the like as used herein describe the relative positions of elements or features, and are not limited to the orientations depicted in the drawings.

The components, blocks, modules, circuits, operations, etc. described may be implemented in hardware, software, firmware, or any combination thereof. Hardware implementation may include, for example, one or more application-specific integrated circuits (ASICs), field-programmable gate arrays (FPGAs), or other programmable logic devices. Software implementation may include, for example, one or more computer programs, firmware, or other executable code. Firmware implementation may include, for example, one or more programs or code that is stored in a non-volatile memory, such as a read-only memory (ROM), a flash memory, or an erasable programmable read-only memory (EPROM).

In various embodiments, the invention may employ non-transitory memory, such as solid-state drives (SSDs) or non-volatile RAM (NVRAM), to store critical program instructions and data necessary for the operation of the system. This non-transitory memory may cooperate with a multi-core CPU architecture featuring Hyper-Threading Technology to potentially enable rapid and reliable data processing, even under heavy network traffic. The non-transitory memory may store system logs, configuration data, and real-time processing outputs, which may contribute to maintaining consistent system performance and reducing latency in data retrieval and storage. Additionally, specialized hardware components like GPUs with Tensor Cores and FPGAs may be integrated to handle specific tasks, such as neural network inference and custom parallel processing, potentially enhancing the system's overall efficiency and adaptability.

The operations of a method or algorithm disclosed herein may be embodied in a processor-executable software module or as processor-executable instructions, both of which may reside on a non-transitory computer-readable or processor-readable storage medium. A processor-executable software module may include, for example, a computer program, firmware, or other executable code that is executed by a processor. Processor-executable instructions may include, for example, one or more instructions that are executed by a processor.

The computer systems described herein may be networked systems, capable of communicating with other devices and systems over various types of networks, including both cellular and fixed networks, as well as near-field and local wireless communication technologies. These systems typically include one or more network interfaces, which may be wired (e.g., Ethernet, fiber optic) or wireless (e.g., Wi-Fi, cellular, satellite, Bluetooth, Near Field Communication (NFC), and ANT). The network interfaces facilitate data transmission using standard communication protocols such as Transmission Control Protocol/Internet Protocol (TCP/IP), Hypertext Transfer Protocol (HTTP/HTTPS), File Transfer Protocol (FTP), Simple Mail Transfer Protocol (SMTP), or proprietary protocols.

In cellular-based systems, such as smartphones or Internet of Things (IoT) devices, the network interface may utilize protocols like 4G LTE, 5G, or future cellular standards. For short-range, non-cellular communication, the system may include technologies such as Bluetooth (IEEE 802.15.1), NFC (ISO/IEC 18092), and ANT, each operating under distinct wireless communication standards. These protocols enable close-proximity data exchanges, with Bluetooth supporting device pairing over moderate distances, NFC enabling contactless interactions within a few centimeters, and ANT supporting low-power, low-bandwidth communication primarily in sports and fitness devices.

For fixed networked servers operated by individuals or companies, the systems may employ high-bandwidth connections and incorporate technologies like load balancing, redundancy, and other enterprise-grade networking features to ensure reliability and scalability.

The software stack in these networked systems typically includes an operating system (e.g., Linux, Windows Server, IOS, Android), networking software, security solutions (e.g., firewalls, encryption), and application-specific software. Additionally, virtual private networks (VPNs) and secure communication platforms may be utilized for private or secure data exchanges. These components collectively enable secure, efficient data transfer and processing across local area networks (LANs), wide area networks (WANs), and the global Internet.

System-on-Chip (SoC) refers to an integrated circuit that integrates all or most components of a computer or other electronic system into a single chip. These components typically include a central processing unit (CPU), memory, input/output ports, and secondary storage-essentially providing all or most of the necessary computing functionality on a single chip. SoCs are widely used in embedded systems and mobile devices due to their compact size, lower power consumption, and cost-effectiveness. System-on-Module (SoM), also known as Computer-on-Module (COM), is a type of single-board computer that is designed to plug into a carrier board. SoMs contain core computing functionality, including the processor, memory, and basic I/O, while the carrier board provides additional functionality and connections specific to the end application. This modular approach allows for greater flexibility in design and easier upgrades.

Both SoC and SoM designs are commonly used in resource-optimized computing devices, where factors such as size, power consumption, and specific task optimization are crucial. These devices often have limited resources compared to general-purpose computers, necessitating carefully optimized firmware or operating systems.

Firmware refers to software that is embedded in a hardware device, providing low-level control for the device's specific hardware and directly interacts with the hardware. An operating system, on the other hand, is software that manages computer hardware, software resources, and provides API for higher level computer application. A development tool or toolchain or build tool or software development kit (SDK)—used by developers to generate a firmware or an operating system image or compile an application along with accompanied libraries for a specific hardware platform and throughout this document these terms are used interchangeably.

For SoC and SoM devices, the line between firmware and operating system can often blur, with many devices running a lightweight operating system that performs many traditional firmware functions. Throughout this document, “firmware or operating system image” refers to the software package that is installed on the SoC or SoM to control its operation and provide its core functionality.

The preceding description of the disclosed aspects is provided to enable any person skilled in the art to make, implement, or use the claims. Various modifications to these aspects will be readily apparent to those skilled in the art, and the generic principles defined herein may be applied to other aspects without departing from the scope of the claims. Thus, the present disclosure is not intended to be limited to the specific embodiments described herein but is to be accorded the widest scope consistent with the claims.

### TECHNICAL FIELD

The present invention relates to the delivery of embedded software build tools offered by hardware vendors for specialized or non-generic computing devices, specifically targeting System-on-Chips (SoCs) and System-on-Modules (SoMs). SoCs and SoMs are widely utilized in various applications, including but not limited to embedded systems. Internet of Things (IoT) devices, and resource-constrained environments.

### PRIOR ART

US PATENT DOCUMENT

| | |
|---|---|
| i. | U.S. Pat. No. 10,606,606 B1 31/2020 Madhan et al. G06F 1/32; 1/28 |
| ii. | U.S. Pat. No. 11,809,850 B2 7 Nov. 2023 Sudhanva et al. |
| iii. | U.S. Pat. No. 10,732,960 B2 8 Apr. 2020 Kannan et al. |
| iv. | WO 2006/068845 A2 29 Jun. 2006 WIEDMAN, LAWRANCE |
| v. | US20030236927 G06F9/00; G06F9/44; G06F9/445; (IPC1-7): |
| | G06F9/00 |
| vi. | US20160283218 |

1. A system for delivering embedded software build tool, comprising:
a user facing application comprising a REST API module and a command processing engine configured to receive user input specifying parameters for software image generation;
a plurality of middlewares, configured to identify node managers based on the user input and target hardware specifications;
a plurality of node managers, each configured to select a build executor node and trigger corresponding build executor scripts;
a plurality of executor nodes, each configured with specific version of build tools along with a build executor script;
wherein the system is configured to:
provide, by a vendor, a group of executor nodes with a specific version of software build tool along with a build executor script to generate a software image for a specific resource-optimized computing device, the executor nodes are managed by the vendor, allowing user access via a user facing application, wherein the user facing application receives a software image generation request for a specific resource-optimized computing device, the software image generation request comprising a parameter;
receive, via the user facing application, a request to generate a software image for a specific resource-optimized computing device;
determine, based on the request, comprising a target architecture, software image type, build tool and build tool version;
select, an appropriate executor node from the plurality of executor nodes based on the determined target architecture, software image type, build tool and build tool version;
generate, using the selected executor node, the requested software image tailored for the specific resource-optimized computing device; and
output, the generated software image by storing on a storage repository.

2. The system of claim 1, wherein the user facing application receives a user request via the RESTful API or via the command processing engine.

3. The system of claim 1, wherein the software image type is limited to a toolchain or a firmware or an operating system image or an over-the-air update image.

4. The system of claim 1, wherein the build executor script work with resource-optimized computing device specific build tool.

5. The system of claim 1, wherein the executor nodes are computing devices capable of executing build execution scripts.

6. The system of claim 1, wherein the build tool is a hardware vendor provided or recommended build tool for the target resource-optimized computing device.

7. The system of claim 1, wherein the generated software image can contain user provided data.

8. A method for delivering embedded software build tool, comprising:
providing, by a vendor, a group of executor nodes with a specific version of software build tool along with a build executor script to generate a software image for a specific resource-optimized computing device, the executor nodes are managed by the vendor, allowing user access via a user facing application, wherein the user facing application receives a software image generation request for a specific resource-optimized computing device, the software image generation request comprising a parameter;
receiving, via the user facing application, a request to generate a software image for a specific resource-optimized computing device;
determining, based on the request, comprising a target architecture, software image type, build tool and build tool version;
selecting, an appropriate executor node from the plurality of executor nodes based on the determined target architecture, software image type, build tool and build tool version;
generating, using the selected executor node, the requested software image tailored for the specific resource-optimized computing device; and
outputting, the generated software image by storing on a storage repository.

9. A non-transitory computer-readable medium storing instructions that, when executed by a processor, cause the processor to perform a method for delivering embedded software build tool, the method comprising:
providing, by a vendor, a group of executor nodes with a specific version of software build tool along with a build executor script to generate a software image for a specific resource-optimized computing device, the executor nodes are managed by the vendor, allowing user access via a user facing application, wherein the user facing application receives a software image generation request for a specific resource-optimized computing device, the software image generation request comprising a parameter;
receiving, via the user facing application, a request to generate a software image for a specific resource-optimized computing device;
determining, based on the request, comprising a target architecture, software image type, build tool and build tool version;
selecting, an appropriate executor node from the plurality of executor nodes based on the determined target architecture, software image type, build tool and build tool version;
generating, using the selected executor node, the requested software image tailored for the specific resource-optimized computing device; and
outputting, the generated software image by storing on a storage repository.
